(19) United States
(12) Patent Application Publication
(10) Pub. No.: US 2023/0062941 A1
(43) Pub. Date: Mar. 2, 2023

(54) SYSTEMS AND METHODS FOR ASSESSING REGULATORY COMPLIANCE

(71) Applicant: Solvent Herba, LLC, Durango, CO (US)

(72) Inventors: Matt Ozvat, Durango, CO (US); Adam Gifford, Durango, CO (US); Ryan Hentz, Durango, CO (US); Robert Hanson, Durango, CO (US)

(73) Assignee: Solvent Herba, LLC, Durando, CO (US)

(21) Appl. No.: 17/893,981

(22) Filed: Aug. 23, 2022

Related U.S. Application Data
(60) Provisional application No. 63/237,047, filed on Aug. 25, 2021.

(51) Int. Cl. G06Q 30/00; G06Q 10/06

(52) U.S. Cl. CPC G06Q 30/018; G06Q 10/0635

(57) ABSTRACT

A system and methods are provided to provide visual indications of a relative compliance level of a business associated with a user of the first user device and to a second user device. The system may include a server computer including a payments processor server and an automated data processor, a first user device having a portal connected to the server computer. The system may also include a second user device having a portal connected to the server computer.

### TECHNICAL FIELD

The disclosure relates generally to systems and methods to industries that are heavily regulated and require significant efforts for compliance. For example, items that can be imported into specific countries based on import laws in those countries, must be closely watched by the importer requiring significant effort and time to ensure compliance with underlying regulation. The systems and methods disclosed herein monitor transactions and calculate a health score for indicating relative compliance with regulatory requirements.

### BACKGROUND

Importing and exporting items between countries can be a significant burden on business interests. For example, restrictions on goods that are legal to import or export in certain countries have a host of compliance terms for satisfying legal requirements for import and export. Examples of such goods are weapons of various kinds, legal and semi-legal drugs, endangered species (e.g., elephant ivory) or products that use endangered species (e.g., specialty woods from endangered trees) may be used or imported in some cases for various reasons, under exceptions built into regulatory schema. Certain coffee beans, raw meats, dried meats, types of meats are seemingly innocuous goods for import and export that are subject to substantial scrutiny under import and export laws. However, compliance with these regulations and assessing where risks are and are not, can be overwhelmingly difficult, if not impossible for importers/exporters to accurately assess. This is particularly concerning when compliance failure results in heavy fines or potentially jail time.

In some cases, banking laws in the United States, prevent business that transport and sell these, and other, exemplary goods from using banks for executing financial transactions, holding money, receiving loans, and many other financial services, such as having a checking account or an operating account, access to debit or credit cards, and other bank services. This is simply because regulations prohibit banks from transacting business for goods that are illegal, or questionably legal. Thus, a significant disconnect exists between producers of goods, who are operating legally, and banks which wish to shield themselves from regulatory backlash. Many of these industries have been successful enough to operate without banks or participate in fraudulent transactions to access bank services, even for goods that are obtained, imported, exported, acquired, or disposed of legally.

It is therefore one object of this disclosure to provide a system which provides a monitoring service for fraudulent transactions. It is another object of this disclosure to provide a system that confirms regulatory compliance to satisfy banking requirements while providing a score to the end user for acceptable compliance. It is another object of this disclosure to provide a method for providing compliance metrics, and notifications to both a banking user and an entity transacting business with respect to certain goods that a potential business arrangement may or may not be fraudulent, or posing a risk outside predetermined thresholds.

### SUMMARY

A system is provided which includes a server computer. The server computer includes a first automated data processor. The system further incorporates a second automated data processor connected to the server computer and a third automated data processor connected to the server computer. The system further incorporates a first user device having a user portal connected to the second automated data processor. The system also incorporates a second user device having a portal connected to the third automated data processor. The second automated data processor generates a risk gradient and a risk score for the user of the first device that provides a visual indication on the first user device of a relative compliance level of an entity associated with the user of the first device and provides a visual indication on the second user device of the relative compliance level of the entity associated with the user of the first user device.

A method is also provided which includes collecting data from a first user device and collecting data from one or more data sources. The method includes weighting the data from the data sources according to one or more regulation and analyzing data collected from the first user device with the weighted data from the data sources. The method includes generating a risk score or a risk gradient of one or more transactions based on the analysis of the data collected from the first user device and providing a notification of the risk score or the risk gradient to a first device or a second device.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings:

FIG. 1 illustrates a block diagram of a system for continuously monitoring compliance risk.

FIG. 2 illustrates a flowchart for a method for continuously monitoring compliance risk.

FIG. 3 illustrates a flowchart for generating a compliance risk gradient and risk score.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

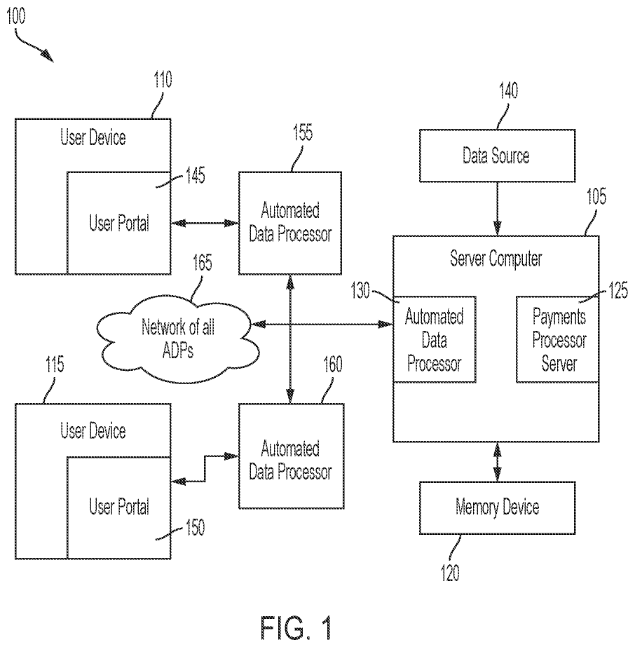

FIG. 1 illustrates a block diagram of a system 100 for continuously monitoring compliance risk. In one embodiment, system 100 includes a server computer 105, a user device 110 and a second user device 115. Server computer 105 may further be connected to a memory device 120 and include a payments processor server 125, and a server ADP (automated data processor) 130 which may be implemented with or as part of other devices which may include a combination of processors, microcontrollers, busses, volatile and non-volatile memory devices, non-transitory computer readable memory device and media, data processors, control devices, transmitters, receivers, antennas, transceivers, input devices, output devices, network interface devices, decentralized blockchain ledgers, and other types of components that are apparent to those skilled in the art.

Server computer 105 may further have access to data sources, such as data sources 140, which will be discussed below, by wired or wireless connections, through, for example, the Internet. Data sources may include any information external to server computer 105 that is publicly available through the Internet, such as public state business information, for example. Exemplary wired or wireless connections may include may be implemented using Wi-Fi, ZigBee, Z-Wave, RF4CE, Ethernet, telephone line, cellular channels, or others that operate in accordance with protocols defined in IEEE (Institute of Electrical and Electronics Engineers) 802.11, 801.11a, 801.11b, 801.11e, 802.11g, 802.11h, 802.11i, 802.11n, 802.16, 802.16d, 802.16e, or 802.16m using any network type including a wide-area network (“WAN”), a local-area network (“LAN”), a 2G network, a 3G network, a 4G network, a 5G network, a Worldwide Interoperability for Microwave Access (WiMAX) network, a Long Term Evolution (LTE) network, Code-Division Multiple Access (CDMA) network, Wideband CDMA (WCDMA) network, any type of satellite or cellular network, or any other appropriate protocol to facilitate communication.

User device 110 may be implemented as a smart phone, a tablet, a laptop computer, a desktop computer, a music storage and playback device, a personal digital assistant, or any other device incorporating a processor which is capable of implementing a software application that may interact with, control, and provide information to user ADP (automated data processor) 155 through, for example, a user portal 145 to user ADP 155 through the Internet with any of the exemplary wired or wireless connections discussed herein. User ADP 155 may communicate with server computer 105 through the Internet with any of the exemplary wired or wireless connections discussed herein.

User device 115, may also be implemented as a smart phone, a tablet, a laptop computer, a desktop computer, a music storage and playback device, a personal digital assistant, or any other device incorporating a processor which is capable of implementing a software application that may interact with, control, and provide information to user ADP (automated data processor) 160 through, for example, a user portal 145 to user ADP 160 through the Internet with any of the exemplary wired or wireless connections discussed herein. User ADP 160 may communicate with server computer 105 through the Internet with any of the exemplary wired or wireless connections discussed herein.

In implementation, a particular merchant or business entity whose business is perceived to include compliance risk, may be denied access to banking services, for example, because of the perceived risk associated with the business' compliance with regulatory requirements set by a governmental entity, such as a city, county, state government or the federal government. A pharmacy, for example, may dispense drugs but carry substantial risk of regulatory compliance for a host of reasons, including not having a licensed pharmacist, dispensing and having access to controlled substances, having pharmacy technicians that have a background of drug use or stealing, for example. And, on this basis, banks may deny access to banking services for the relative risk or liability the banks would incur under regulatory schema. In another system, a governmental state based regulator may view the risk of non-compliance for particular merchants with respect to immunization records for employees, COVID-19 protocols, ongoing COVID testing for employees, and the like, to operate a restaurant or a movie theater in a particular state government. System 100 provides a link between a merchant and a risk evaluator which allows the merchant to demonstrate, by a third party, that they have complied with the regulatory framework for a particular business enterprise.

To that end, a merchant may access server 105 through user device 110 user portal 145, and user ADP 155 to provide information about the merchant's business entity or services. For example, the merchant may provide information to server computer 105 about the employees employed by the merchant's business, the type of business entity the merchant owns, the corporation registration information, their business license information, employee background checks, contracts with employees, contracts with vendors, contracts with customers, bank statements, and any other information that may be evaluated for credibility. Information may also be retrieved from user device 110 which may also be a data source in system 100. Once received by server computer 105, server ADP 130 may provide the information to user ADP 155. User ADP 155 may analyze the merchant's information and assign a risk level to the business based on the perceived risk based on the type of business and assign a merchant code to the business which depends on the perceived risk. For example, a licensed pharmacy may be lower risk as a business type than a retail business, which may be less risky than other medicinal businesses in terms of regulatory compliance. Various business types are assigned merchant codes, however, based on the different types of services provided by each business. The merchant's information may then be sent to server ADP 130.

Once this information is received by server ADP 130, the server ADP 130 may perform checks on the information using data sources 140. Server ADP 130 may conduct independent verification of the merchant's information to check finances, banking information, business incorporation information, business license information, perform employee background checks, review COVID vaccine sources, and verify as much information provided by the merchant is accurate and up to date. The reliability of this information may be used as a factor to determine credibility and used to assess a risk factor with the accuracy of the information provided against the information retrieved by server ADP 130 through data sources 140. If the information is accurate and consistent with information obtained by server ADP 130 through data sources 140, a merchant entity may be credited as having a lower risk factor than a merchant entity whose information does not match the information obtained by server ADP 130 through data sources 140. Further, information provided by the merchant, retrieved from user device 110, or obtained by server ADP 130 through data sources 140 may be provided to user ADP 155 to be weighted based on perceived risk associated with the merchant's services and the merchant's information.

For example, if a merchant's incorporation information has an incorrect address, one of the employees has convictions for theft crimes or drug dealing convictions, is unvaccinated for COVID or other vaccines, this information can be analyzed and weighted by user ADP 155 to generate a risk score based on these factors to give the user of user device 110 a generic status of “health” for a business with a risk gradient with a visual indication. The risk gradient may be expressed as a percentile of perceived risk associated with the risk factors discussed above, once weighted. The visual indication of the risk gradient may be expressed as a percentile, such as 85% compliance or 90% compliance. The user of user device 110 may receive a report as another visual indication of a risk score based on their particular threshold that indicates a “green” threshold level which indicates that the compliance threshold is met, a “yellow” threshold level that indicates that there are potential compliance issues along with a list of those issues that are causing the “yellow” threshold level, and a “red” threshold level that indicates that there are compliance issues along with a list of those issues that are causing a “red” threshold level. For example, a green threshold level may indicate that user ADP 155 has found no or minor risk factors, such as a required renewal of a business license in the near future. A yellow threshold level may indicate that user ADP 155 has determined that the threshold level of compliance set by the merchant entity is below an acceptable range due to an employee failing to provide immunization record checks, for example. A red threshold level may indicate that user ADP 155 has determined that the threshold level of compliance set by the merchant is well below an acceptable range that could cause issues with acquiring banking services, for example. Server ADP 130 and user ADP 155 may further continuously monitor, down to an hourly basis or less, or on a weekly or monthly basis, relative risk compliance and provide reports to the merchant, the user of user device 110.

Once a risk gradient and a risk score have been generated by user ADP 155, the risk gradient and risk score may be sent to server 105 for encryption and storage on memory device 120 and a notification may be sent to the user through user ADP 155. Notifications may be emails, status updates in the user portal 145, text messages, telephone, or any other information exchange protocol. The merchant may have an opportunity to correct any errors that exist in the information provided or address pending issues to ensure their risk gradient and risk score meet their minimum threshold.

The merchant, the user of user device 110, may then choose to share a risk gradient and risk score with another user. For example, the merchant entity's risk gradient and risk score may be transmitted from server ADP 130 to user ADP 160. User ADP 160 may then send notifications of merchant's risk gradient and risk score to user portal 150 for access by a second user through user device 115. For example, a bank official or a state regulator, or even a federal regulator, may access user device 115 to receive information from user portal 150 concerning the relative risk compliance of the user's business and determine whether or not the risk gradient and risk score for the merchant's business entity are acceptable. In this way, however, server computer 105 provides an evaluation of risk assessment for businesses that have more stringent regulatory schema to follow for the type of business and services being provided.

Additionally, server ADP 130, user ADP 155, user ADP 160, and other system ADPs may be networked. Thus, ADP network 165, comprised of a network of system ADPs may be provided as illustrated in FIG. 1. Each ADP may receive and send encrypted data and decrypt data received from other ADPs. ADPs may also send unencrypted data as necessary. ADPs may also process data in real time to derive risk gradients and risk scores for users, such as merchants as discussed in the example above. FIG. 1 indicates whether data communication may be one-way or two-way. For example, data communication from data sources 140 to server computer 105 is one-way as indicated by a single arrow, whereas data communication between other devices may be two-way as indicated by bidirectional arrows.

Risk gradients and scores may be sent to subscribers based on arbitrary, reconfigurable parameters. Such parameters may include time intervals, changes in risk gradients and/or changes in risk scores, specific risk gradient or risk score result qualities, ad hoc requests, and other parameters known to persons having ordinary skill in the art.

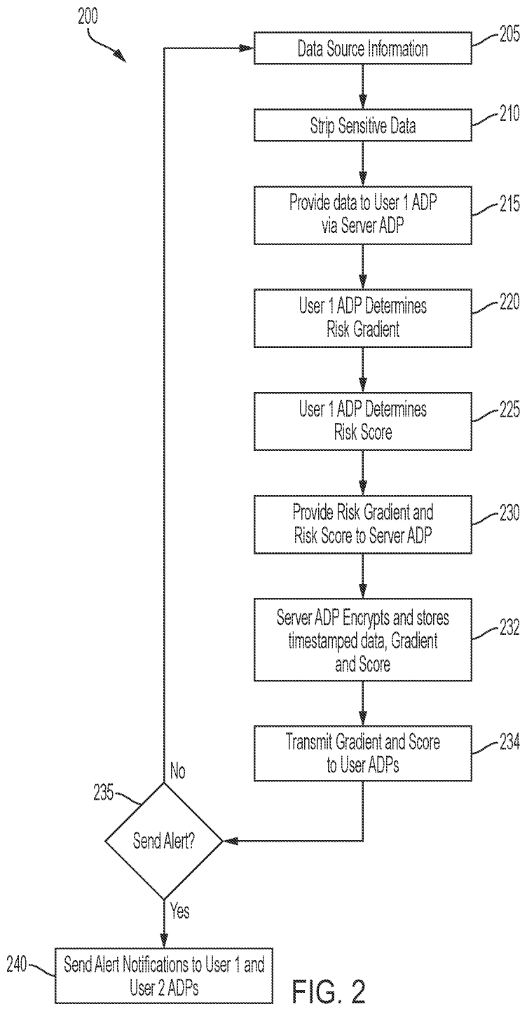

FIG. 2 illustrates a method 200 for continuously monitoring compliance risk. At step 205, server ADP 130 may receive data source information from user device 110 by way of user portal 145 and user ADP 155, and data sources 140, as shown in FIG. 1 and discussed above. Server ADP 130 may strip sensitive data from the user data source information to ensure privacy and store this information in memory device 120 at step 210. The data source information may be provided to user ADP 155 via server ADP 130 at step 215 to allow user ADP 155 to review and analyze the information obtained through user portal 145 from user device 110 as compared to data sources 140 that are obtained directly by server computer 105 and server ADP 130.

Once the data source information is collected and analyzed, the data source information may be used by user ADP 155 to generate a risk gradient at step 220. The risk gradient may be expressed in percentage terms for relative levels of compliance with business entity services, contracts, employee background checks, and potential risks associated with a merchant's business enterprise or entity. At step 225, a risk score may be generated by user ADP 155 which identifies a “green” threshold level, a “yellow” threshold level, and a “red” threshold level, as discussed above. The risk gradient and risk score may be provided at step 230 to server ADP 130. At step 232 server ADP 130 may encrypt and store time-stamped data, risk gradient, and risk score in memory device 120, shown in FIG. 1, for example. A merchant's risk gradient and risk score may be then transmitted to the proper user ADPs, for example user ADP 155 and user ADP 160 at step 234.

At step 235, user ADPs, for example user ADP 155 and/or user ADP 160, may detect a compliance issue or a change based on an analysis of the data source information and determine whether or not to send an alert to either the merchant, the user of user device 110 or a bank officer, a state regulator, or a federal regulator, the user of user device 115 or both. If nothing has changed and no new compliance issues are found (Step 235— “No”), user ADP 155 may return to step 205. If changes have been found and compliance issues have been resolved or new compliance issues have arisen, an alert notification may be sent at step 240 to alert the user of user device 110, the user of user device 115, or both that a compliance risk has changed.

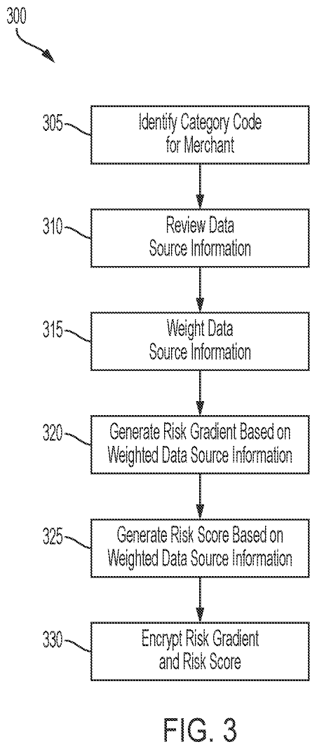

FIG. 3 illustrates a method 300 for generating a compliance risk gradient and risk score. For example, method 300 may be executed by system 100 shown in FIG. 1 and illustrates details of step 220 and step 225 shown in FIG. 2. Method 300 may begin at step 305 to identify a category code for a merchant which corresponds to a relative risk level for the merchant's business type, as discussed above. At step 310, user ADP 155 may review data source information and apply weighting to data source information to enhance the effect of risk factors that create more risk with regulatory schema and decrease the effect of risk factors that create less risk with regulatory schema to get a more accurate assessment of overall risk at step 315.

At step 320, user ADP 155 may generate a risk gradient based on the weighted data source information produced at step 315. At step 325, user ADP 155 may generate a risk score based on the weighted data source information produced at step 315. The risk gradient and risk score may then be encrypted at step 330. The risk gradient and the risk score may be provided to one or more users at step 230 of FIG. 2.

In this manner, a relative risk assessment may be performed by a third party, the operator of server 105 and user ADP 155 to provide access to banking and regulatory services that would otherwise be complex and difficult to navigate directly for merchants.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A system, comprising:
a server computer including a first automated data processor;
a second automated data processor connected to the server computer;
a third automated data processor connected to the server computer;
a first user device having a user portal connected to the second automated data processor;
a second user device having a portal connected to the third automated data processor;
wherein the second automated data processor generates a risk gradient and a risk score for the user of the first user device that provides a visual indication on the first user device of a relative compliance level of an entity associated with a user of the first user device and provides a visual indication on the second user device of the relative compliance level of the entity associated with the user of the first user device.

2. The system of claim 1, wherein the relative level of compliance of the entity associated with the first user device confirms compliance with one or more government regulations.

3. The system of claim 1, wherein the relative level of compliance of the entity associated with the first user device confirms regulatory compliance with one or more banking requirements; The system of claim 1 wherein at least one of the risk gradient and the risk score is encrypted.

4. The method of claim 1, wherein at least one of the second automated data processor and the third automated data processor is co-located with the first user device or the second user device.

5. The system of claim 1, wherein at least one of the first automated data processor, the second automated data processor, and the third automated data processor is included in a network of automated data processors.

6. The system of claim 1, further comprising a memory device wherein the memory device is at least one of a semiconductor storage device, a magnetic storage device, an optical storage device and a decentralized blockchain ledger.

7. The system of claim 1, wherein the server computer receives data from one or more data sources external to the system.

8. The system of claim 1, wherein the risk score or the risk gradient is comprised of reconfigurable parameters including at least one of a time interval, a change in the risk score, a change in the risk gradient, a specific risk score, a specific risk gradient result quality, and an ad hoc request.

9. A method, comprising:
collecting data from a first user device;
collecting data from one or more data sources;
weighting the data from the data sources according to one or more regulation;
analyzing the data collected from the first user device with the weighted data from the data sources;
generating a risk score or a risk gradient of one or more transactions based on the analysis of the data collected from the first user device; and
providing a notification of the risk score or the risk gradient to a first device or a second device.

10. The method of claim 10, wherein the risk score or the risk gradient of the one or more transactions reflects a relative level of compliance of a user of the first user device with the one or more regulation.

11. The method of claim 10, wherein the one or more regulation is a banking regulation.

12. The method of claim 10, wherein the risk score or risk gradient is generated by an automated data processor.

13. The method of claim 12, wherein the automated data processor is co-located with the first device.

14. The method of claim 13, wherein the automated data processor is one of a network of automated data processors.

15. The method of claim 10, further comprising:
storing at least one of the risk gradient and the risk score on a memory device including at least one of a semiconductor storage device, a magnetic storage device, an optical storage device and a decentralized blockchain ledger.

16. The method of claim 10, further comprising:
providing at least one of the risk score and the risk gradient to a server automated data processor.

17. The method of claim 10, further comprising:
identifying a category code for a user of the first user device which corresponds to a relative risk level for the merchant's business type.

18. The method of claim 10, further comprising:
encrypting at least one of the risk gradient and the risk score.

19. The method of claim 10, wherein the risk score or the risk gradient is comprised of reconfigurable parameters including at least one of a time interval, a change in the risk score, a change in the risk gradient, a specific risk score, a specific risk gradient result quality, and an ad hoc request.

20. The method of claim 10, wherein the notification of the risk score visually indicates a compliance threshold level on the first device or the second device.
